(19) United States
(12) Patent Application Publication
(10) Pub. No.: US 2016/0091708 A1
(43) Pub. Date: Mar. 31, 2016

(54) REFLECTIVE DISPLAY DEVICE

(71) Applicant: SHARP KABUSHIKI KAISHA, Osaka (JP)

(72) Inventors: Richard Simon Tuley, Loughbourough (GB); Christopher James Brown, Oxford (GB)

(21) Appl. No.: 14/501,404

(22) Filed: Sep. 30, 2014

(51) Int. Cl. G02B 26/00; G02B 5/02; G02B 5/22; G02B 26/08

(52) U.S. Cl. CPC G02B 26/004; G02B 26/0816; G02B 5/0284; G02B 5/22

(57) ABSTRACT

A reflective pixel for a display device includes a first substrate, a membrane formed relative to the first substrate, and a fluid arranged between the first substrate and the membrane. An actuator mechanism is operative to move the membrane between at least a first and second position that differ in average separation distance relative to the first substrate to produce a low reflective state and a high reflective state of the pixel.

### TECHNICAL FIELD

The invention relates to the field of reflective displays. Such reflective displays may be used in tablets, e-readers, mobiles, watches and other wearable or portable displays.

### BACKGROUND ART

Reflective displays are already well known in the prior art, with potential advantages over more conventional emissive displays including better readability in high ambient light conditions such as sunlight, and lower power operation.

U.S. Pat. No. 8,643,935B2 (Miles, Feb. 4, 2014) discloses a reflective display which has an array of devices. Each device comprises of a substrate; a transparent conducting layer disposed over the substrate; a semiconductor layer disposed over the substrate; and a movable metallic reflector disposed over the substrate. The metallic reflector is movable between a first position and a second position upon application of a voltage between the transparent conducting layer and the metallic reflector. This device can be used in an interferometric reflective display.

U.S. Pat. No. 7,643,203B2 (Gousev et al., Jan. 5, 2010) discloses a reflective interferometric display using a moveable reflective layer, and an absorbing layer.

U.S. Pat. No. 8,115,987B2 (Bita et al., Feb. 14, 2012) discloses an optically resonant cavity comprising a first reflective layer, a partially reflective second layer and a dielectric stack supporting and separating these layers. This optically resonant cavity uses optical interference. This optically resonant cavity is partially filled with a fluid, which can be absorbing, with the fluid coverage controlled by an external voltage.

US20130010341A1 (Hagwood et al., Jan. 10, 2013) discloses using dye molecules in solution in a display using moving shutters. The dye molecules absorb some or all of the visible light to increase the contrast of the display.

US20130278991A1 (Daniel et al., Oct. 24, 2013) discloses a display with a transparent actuator element on a layer of colored fluid. Upon actuation of the transparent actuator, the thickness of the fluid is modulated, modulating the optical density. The actuation mechanism may be electrostatic.

For widespread adoption of reflective displays, they are likely to require the following properties: high reflectivity, high frame rates, good colour depth, high reliability and ease of manufacture. Commercially available reflective displays do not simultaneously fulfil all of these properties

### SUMMARY OF INVENTION

A device and method in accordance with the present invention can simultaneously provide high reflectivity, high frame rates, good colour depth, high reliability and ease of manufacture.

In accordance with the present invention, a reflective display panel comprises a plurality of display pixels wherein each display pixel includes a reflective membrane formed on a first substrate. The display panel further comprises a second substrate arranged in opposition to the first substrate so that the reflective membrane is positioned between the first and second substrates. The first and second substrates form a cell that is filled with an absorbing fluid. At least one of the first and second substrates is substantially transparent. The reflective membrane in each display pixel of the plurality of display pixels may be individually controlled to move to at least two different positions. These positions differ in the membrane's average separation from a transparent substrate. Actuation of the reflective membrane to move to at least one position may be electro-statically controlled.

In one embodiment, a reflective pixel for a display device includes: a first substrate; a membrane formed relative to the first substrate; a fluid arranged between the first substrate and the membrane; and an actuator mechanism operative to move the membrane between at least a first and second position that differ in average separation distance relative to the first substrate to produce a low reflective state and a high reflective state of the pixel.

In one embodiment, the membrane is a reflective membrane and the fluid is an optically absorbing fluid.

In one embodiment, the membrane is an optically absorbing membrane and the fluid is a reflective fluid.

In one embodiment, the actuator mechanism includes: a membrane electrode electrically connected to the membrane; a control electrode electrically isolated from the membrane electrode; and a controller operatively coupled to at least one of the membrane electrode or the control electrode and operative to electro-statically actuate the membrane through application of a potential difference between the membrane electrode and the control electrode.

In one embodiment, the controller is configured to produce an intermediate reflective state of the pixel by varying a time duration in which the membrane is in the low reflective state and the high reflective state.

In one embodiment, the controller is configured to generate an average intermediate reflective state by placing the pixel in one reflective state and at least one adjacent pixel in a different reflective state.

In one embodiment, the membrane includes a reflective layer formed on at least a portion of the membrane.

In one embodiment, the membrane is formed from a reflective material.

In one embodiment, the first substrate is substantially transparent to visible light.

In one embodiment, the reflective pixel display includes a second substrate arranged relative to the first substrate, wherein the reflective membrane is arranged between the first substrate and the second substrate, and at least one of the first and second substrate is substantially transparent to visible light.

In one embodiment, the fluid arranged between the membrane and the first substrate is also arranged between the second substrate and the membrane.

In one embodiment, the reflective pixel display includes a membrane support attached to the membrane and one of the first substrate or the second substrate.

In one embodiment, the membrane support is laterally separated from the membrane and further comprising a linking element connected between the membrane and the membrane support.

In one embodiment, the reflective pixel display includes a plurality of electronic control elements integrated into a surface of one of the first substrate or the second substrate.

In one embodiment, at least a first portion of the membrane or linking element lies in a first plane, and a second portion of the membrane or linking element lies in a second plane different from the first plane.

In one embodiment, the membrane comprises at least one hole that enables the fluid to pass therethrough.

In one embodiment, the membrane is attached to one of the first substrate or the second substrate, and the control electrode is attached to the same first substrate or second substrate.

In one embodiment, the membrane is attached to one of the first substrate or the second substrate, and the control electrode is attached to the other of the first substrate or the second substrate.

In one embodiment, the reflective pixel display includes: a return electrode arranged on one of the first substrate or the second substrate, the return electrode electrically isolated from the membrane; and a drive electrode arranged on the other of the first substrate or the second substrate, the drive electrode electrically isolated from the membrane, where when in the first position the membrane is separated from the drive electrode by a first average separation distance, and when in the second position the membrane is separated from the drive electrode by a second average separation distance, the first average separation distance being different from the second average separation distance.

In one embodiment, the membrane is configured to diffusely reflect light.

In one embodiment, the reflective pixel display includes an optical diffuser.

In one embodiment, the reflective pixel display includes a color filter.

In one embodiment, a display device includes a plurality of reflective pixels as described herein.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 shows a typical implementation of an array of reflective pixels in a reflective display.

FIG. 2 shows a side view of an individual display pixel in accordance with the first embodiment of the invention, with the viewer positioned at the top of the figure.

FIG. 3 shows a plan view of a reflective membrane in accordance with the structure of FIG. 2.

FIG. 4 shows an example fabrication process flow by which the reflective display could be made.

FIG. 5 shows the structure of FIG. 2 when displaced towards the substrate 210.

FIG. 6 shows the electromechanical change in position of the reflective membrane in response to a potential difference between the membrane electrode and another electrode, such as a control, drive or return electrode.

FIG. 7 shows an overview of the driving scheme for an array of display pixels.

FIG. 8A shows an example of the display pixel electrical connections for a passive matrix driving scheme.

FIG. 8B shows an example of the voltage driving scheme for a passive matrix addressing scheme.

FIG. 9 shows an example waveform diagram of electrical signals against time when using a passive matrix addressing scheme in accordance with FIGS. 8A and 8B.

FIG. 10A shows a side view of an individual display pixel having an absorbing membrane in accordance with a second embodiment of the invention, with the viewer positioned at the top of the figure.

FIG. 10B shows the electromechanical change in position for the absorbing membrane in the pixel of FIG. 10A in response to a potential difference between the membrane electrode and another electrode, such as a control, drive or return electrode.

FIG. 11A shows an example of the voltages used in a display pixel to drive a reflective membrane using an active matrix addressing scheme in accordance with the third embodiment

FIG. 11B shows an example of the display pixel circuits for an active matrix driving scheme in accordance with the third embodiment.

FIG. 12 shows an example waveform diagram of electrical signals against time when using an active matrix addressing scheme in accordance with FIGS. 11A and 11B.

FIG. 13 shows a plan view of the reflective membrane in accordance with the fourth embodiment.

FIG. 14 shows a plan view of the reflective membrane in accordance with the fifth embodiment.

FIG. 15 shows a side view of the reflective membrane in accordance with the fifth embodiment.

FIG. 16 shows a plan view of the reflective membrane in accordance with the sixth embodiment.

FIG. 17 shows a side view of an individual display pixel in accordance with the seventh embodiment of the invention, with the viewer positioned at the top of the figure.

FIG. 18 shows the structure of FIG. 17 when displaced towards the substrate 1720.

FIG. 19 shows a side view of an individual display pixel in accordance with the eighth embodiment of the invention, with the viewer positioned at the top of the figure.

FIG. 20 shows the structure of FIG. 19 when displaced towards the substrate 1720.

FIG. 21 shows the structure of FIG. 19 when displaced towards the substrate 1710.

FIG. 22 shows an example of the voltages used in a display pixel to drive a reflective membrane using an active matrix addressing scheme in accordance with the eighth embodiment.

FIG. 23 shows an example of the display pixel circuits for an active matrix driving scheme in accordance with the eighth embodiment.

FIG. 24 shows a side view of an individual display pixel in accordance with the ninth embodiment of the invention, with the viewer positioned at the top of the figure.

FIG. 25 shows the structure of FIG. 24 when displaced towards the substrate 210.

FIG. 26 shows the structure of FIG. 24 when displaced towards the substrate 220.

FIG. 27 shows a side view of an individual display pixel in accordance with the tenth embodiment, with the viewer positioned at the top of the figure.

FIG. 28 shows a side view of an individual display pixel in accordance with the tenth embodiment, with the viewer positioned at the top of the figure.

FIG. 29 shows a side view of an individual display pixel in accordance with the tenth embodiment, with the viewer positioned at the top of the figure.

FIG. 30 shows a side view of an individual display pixel in accordance with the tenth embodiment, with the viewer positioned at the top of the figure.

### DESCRIPTION OF REFERENCE NUMERALS

100 Reflective display panel
110 Display pixel in high reflective state
120 Display pixel in low reflective state
150 Incident light
160 Strongly reflected light from high reflective display pixel
170 Weakly reflected light from low reflective display pixel
180 Display driver
190 Viewer
200 Membrane
205 Reflective surface
210 First transparent substrate
220 Second substrate
230 Control electrode
240 Membrane electrode
250 Membrane support
260 Absorbing fluid
700 Display controller
705 Image data
710 Data drivers
715 Data line interconnect
720 Scan drivers
725 Scan line interconnect
730 Array of display pixels
740 Global electrode lines
800 Display pixel
810 Control electrode
820 Membrane electrode
1000 Absorbing membrane
1250 Membrane support for absorbing membrane
1260 Reflective fluid
1100 Display pixel with active addressing
1130 Transistor
1135 Capacitor
1140 Electrical ground
1150 Membrane assembly
1152 Membrane electrode
1153 Control electrode
1300 Linking element
1400 Line of change of plane in membrane
1410 Rib
1600 Hole in membrane
1700 Membrane
1705 Reflective surface
1710 First substrate
1720 Second transparent substrate
1735 Control electrode
1740 Membrane electrode
1750 Membrane support
1760 Absorbing fluid
1900 Return electrode
1910 Drive electrode
2300 Return electrode
2310 Membrane electrode
2320 Drive electrode
2350 Membrane assembly
2360 Display pixel with active addressing
2400 Return electrode
2420 Drive electrode
2700 Optical diffuser

### DETAILED DESCRIPTION OF INVENTION

In accordance with the present invention, a reflective display panel comprises a plurality of display pixels wherein each display pixel includes a membrane formed relative to a first substrate via an actuator mechanism. A fluid is arranged between the first substrate and the membrane. The actuator mechanism can move the membrane between at least two positions that differ in average separation distance relative to the first substrate to produce a low reflective state and a high reflective state of the pixel. The membrane in each display pixel of the plurality of display pixels may be individually controlled.

The display panel may further comprise a second substrate arranged in opposition to the first substrate so that the membrane, via an actuator mechanism, is positioned between the first and second substrates. Fluid may fill the cell formed between the first and second substrates. At least one of the first and second substrates may be substantially transparent. The membrane in each display pixel of the plurality of display pixels may be individually controlled to move to at least two different positions. These positions differ in the membrane's average separation from a transparent substrate. Actuation of the reflective membrane to move to at least one position may be electro-statically controlled.

The membrane may be a reflective membrane, and the fluid an absorbing fluid. The membrane may be an absorbing membrane and the fluid may be a reflecting fluid.

For the purpose of this invention, a membrane is defined as a solid layer which is attached to a substrate via support structures, but is not attached to the substrate elsewhere. Over 20% of the membrane's side nearest the substrate therefore has a void between it and the substrate. This void can be filled with fluid. The membrane may have a thickness in the range 0.01-100 microns. The membrane may have a size in the range 1-1000 microns.

For the purpose of this invention, a reflective membrane is a membrane in which at least part of one or more of the membrane surfaces is substantially reflective to visible light, forming a reflective surface. The reflection from the reflective surface can be due to the membrane material itself, at least one additional optional layer formed on at least part of one of the surfaces of the membrane, or a combination of the above. The at least one additional layer may be formed over the whole or part of the membrane. The reflective surface has a reflectivity >10% averaged over visible wavelengths. The reflective surface may have a reflectivity >50% averaged over visible wavelengths. The reflected light may be specular or diffuse in nature.

For the purpose of this invention, an absorbing fluid is defined as a fluid which absorbs >50% of light averaged over visible wavelengths in a distance of 100 microns. An absorbing fluid may comprise a fluid which is intrinsically absorbing, or a fluid which contains a suspension of absorbing particles, or a fluid which contains a solution of absorbing material or any combination of the above.

For the purpose of this invention, an absorbing membrane is defined as a membrane which absorbs or transmits >50% of light incident on its surface, averaged over its surface. Thus reflection from the absorbing membrane is <50% of light averaged over visible wavelengths at normal incidence. The absorbing membrane may reflect <10% of light averaged over visible wavelengths. The absorption or transmission through the absorbing membrane may occur on part of the membrane only. The absorption or transmission through the absorbing membrane may occur due to the membrane material itself or due to additional layers on at least part of the membrane or to some combination of the two.

For the purpose of this invention, a reflecting fluid is defined as a fluid which reflects >10% of light averaged over visible wavelengths at normal incidence in a 100 micron thick film. A reflecting fluid may reflect >50% of light averaged over visible wavelengths in a 100 micron thick film. A reflective fluid may include a scattering fluid. A reflecting fluid may comprise a fluid which is intrinsically reflecting or scattering, or a fluid which contains a suspension of reflecting or scattering particles, or a fluid which contains a solution of reflecting or scattering material, or a fluid which contains a mixture or emulsion of at least two different fluids, or any combination of the above. Scattering or reflective particles may include metallic particles or oxides such as titanium dioxide.

For the purpose of this invention, a substantially transparent substrate transmits >10% of light averaged over visible wavelengths through the substrate. Preferably, a substantially transparent substrate transmits >50% of light averaged over visible wavelengths through the substrate.

By predominantly using the phenomenon of optical absorption rather than the phenomenon of optical interference or an optical cavity, the reliability and ease of manufacture can be increased, compared to some conventional reflective type displays, as the required control over device dimensions can be less stringent. The sensitivity of the reflection to viewing angle may also be decreased by using the phenomenon of absorption rather than the phenomenon of optical interference or an optical cavity.

By actuating the solid membranes which then move through the fluid, rather than directly moving the fluid as in an electro-wetting display, there is the potential for higher actuation speeds, increased reliability, and greater flexibility over the choice of fluid. In this invention only a single fluid may be required, which can completely fill the cell formed by the two substrates, including the void between the membrane and the first substrate. This may make the device easier to manufacture, and increases the device's reliability.

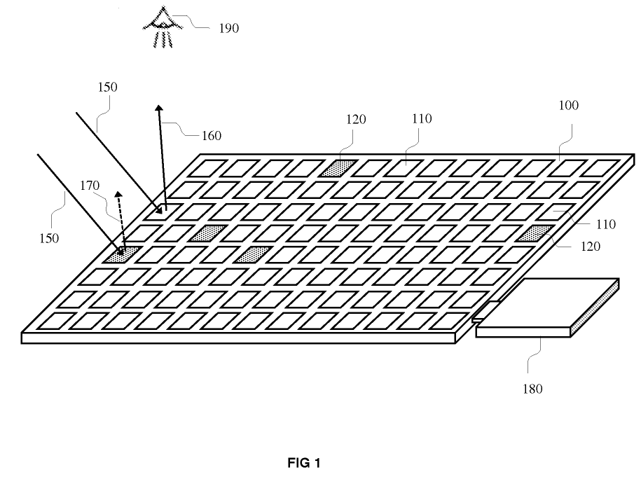

FIG. 1 shows a reflective display, which includes a reflective display panel 100, comprising a plurality of display pixels. These display pixels can be switched between at least two states: a low reflective state 120, and a high reflective state 110. Incident light 150 hits the display panel, and can originate from ambient light such as room lighting, sunlight or a front light providing light from the viewing side of the display. The incident light can be reflected from a display pixel in the high reflective state pixel to generate reflected light 160. Incident light 150 can be reflected from a display pixel in the low reflective state pixel to generate reflected light 170. The different states of the pixel correspond to different intensities of the reflected light averaged over the pixel. The intensities of 160 and 170 averaged over the display pixel therefore differ when the intensity of the incident light 150 on both pixels is the same. This difference can be observed by a viewer 190. Light incident in areas between the display pixels may be substantially absorbed in the display panel.

The display driver 180 controls the state of the pixels. The display driver may be operationally coupled to but separate from the display panel. Alternatively the display driver may be incorporated into the display panel. Thin film transistors or other electrical control elements may be formed on one or both of the first and second substrates and may constitute some or all of the display driver functions.

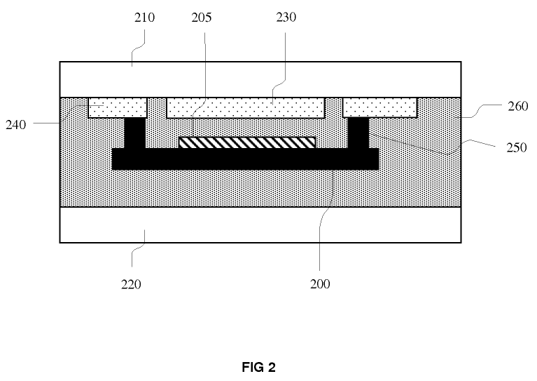

FIG. 2 shows an embodiment of a display pixel in accordance with a first embodiment of the invention. The membrane 200 forms a reflective membrane with a reflective surface 205. The membrane is attached to the first transparent substrate 210 via membrane supports 250. The membrane supports may attach directly to the substrate or to the membrane electrode which lies on the substrate. Membrane electrodes 240 on the first substrate electrically connect to the membrane, which may be electrically conductive. A control electrode 230 is positioned on the first substrate, electrically isolated from the membrane electrode. The control electrode surface, the membrane or both may be covered in an insulating layer to avoid electrical shorting of the membrane to the control electrode during operation. A second substrate 220 is positioned such that the reflective membrane lies between the first and second substrates. The first and second substrates are sealed to form a cell which is filled with absorbing fluid 260. The separation of the first and second substrate may be in the range 0.1 to 200 microns. The first substrate may be arranged so as to be closer to the viewer.

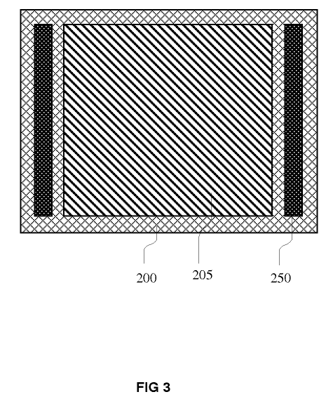

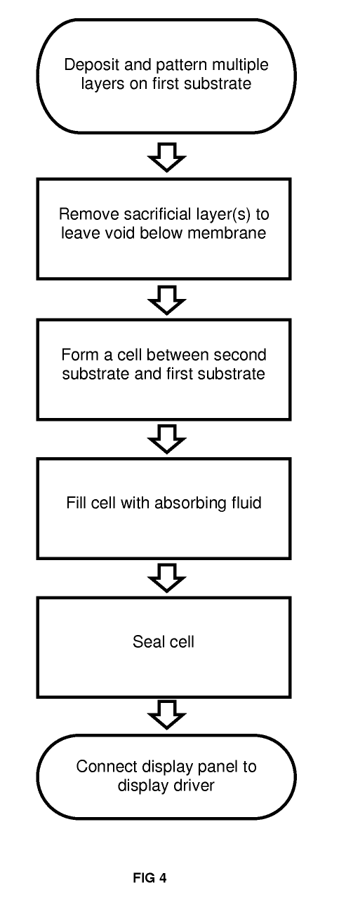

FIG. 3 shows a plan view (from the viewer direction) of an example of a reflective membrane such as used in FIG. 2. The reflective membrane comprises a membrane 200, attached to the first substrate by membrane supports 250. The membrane may be substantially rectangular. The membrane may be any shape which allows a high filling factor of the substrate. The membrane supports only occupy part of the total membrane area. The membrane supports may be near the edges of the membrane. The membrane supports may exist near some edges of the membrane. The membrane supports may exist on some regions near some edges of the membrane. The membrane supports may exist near the centre of the membrane. The membrane has a reflective surface 205. This covers at least part of the membrane. It may cover the whole membrane. It may cover the membrane supports. The reflective membrane and supports may be fabricated on the surface of the first substrate using techniques well-known in the field of micro-electro-mechanical systems (MEMS). For example, the membrane may be made on the first substrate using techniques such as surface micromachining or bulk micromachining. An example of a process flow to form a reflective display as described in these embodiments is shown in FIG. 4.

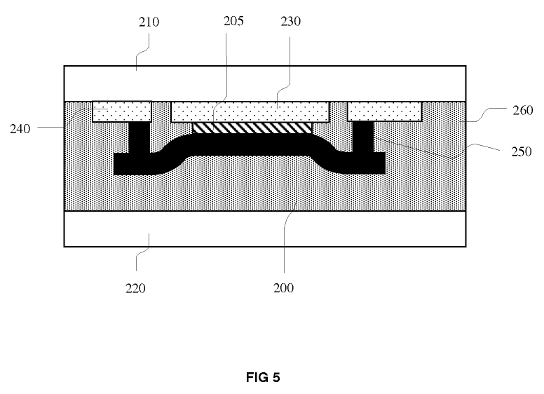

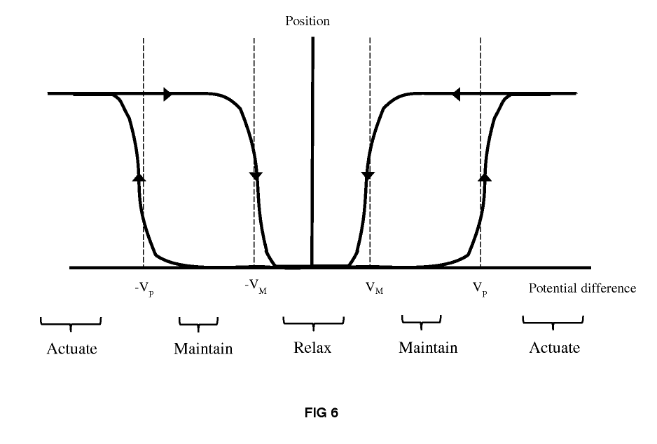

The membrane may be controlled to move between two different states, corresponding to different membrane positions relative to the first transparent substrate. FIG. 2 illustrates the first relaxed state where the membrane is separated from the control electrode by a first average distance. This relaxed state is achieved when the magnitude of the potential difference between the control electrode and membrane electrode is less than a maintain voltage, V_{M}. FIG. 5 illustrates the second driven state where the membrane is pulled in towards the control electrode by an electrostatically generated force. In the driven state the membrane is separated from the control electrode by a second average distance that is less than the first average distance in the relaxed state. The driven state is achieved when the magnitude of the potential difference between the control electrode and the membrane electrode is more than a pull-in voltage, V_{P}. Switching from the relaxed state to the driven state is therefore achieved by electro-static actuation and switching from the driven state to the relaxed state occurs by the mechanical spring action of the membrane and supports. This electro-mechanical characteristic of the membrane is illustrated in FIG. 6 which shows the position of the membrane as a function of the potential difference between the membrane electrode and the control electrode.

In the relaxed state the first average distance is large enough for the average thickness of the absorbing fluid in the void between the reflective membrane and the control electrode or first transparent substrate to absorb a significant proportion of the incident light. The relaxed state therefore corresponds to a low reflectivity state. In the driven state the second average distance is small enough that the average thickness of absorbing fluid in the void does not absorb a significant proportion of the incident light which is substantially reflected back to the viewer. The driven state therefore corresponds to a high reflectivity state. Actuation of the membrane therefore allows switching between a high reflective state and a low reflective state.

The position of the reflective membrane in the driven state may be such that it is partially or fully in contact with the control electrode. Alternatively, the membrane may not be in contact with control electrode in the driven state. In the latter case there exists an absorbing fluid filled gap between the reflective membrane and the control electrode at all times. Such a non-contact state may be used as an additional intermediate state, and can be actuated by a potential difference between the membrane and the control electrode that is less than the pull in voltage, V_{P}. Such an intermediate state has an average reflection over visible wavelengths that is in between the low and high reflective states. Many intermediate states, with different average reflections, are possible by varying the potential difference between the membrane and control electrode, with the potential difference below the pull-in voltage.

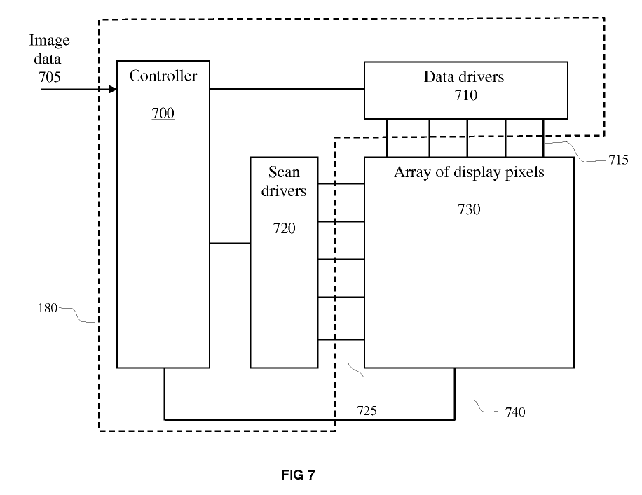

FIG. 7 shows a block diagram of an exemplary arrangement of display driver 180 and an array of display pixels 730. The display driver 180 comprises a display controller 700 which is connected to data drivers 710 and scan drivers 720. In operation image data 705 is sent to the display driver 180. Image data is written row by row to the array of display pixels 730, with the data transferred to the array of display pixels from the data drivers by the data line interconnects 715. There may be one data line interconnect for each column of display pixels. The selection of which rows of display pixels to write the data on the data line interconnects to, is controlled by the signal on the scan line interconnects 725. The scan line interconnects are controlled by the scan drivers. There may be one scan line interconnect for each row of display pixels. The controller 700 may also control any global electrodes in the array of display pixels by the global electrode lines 740.

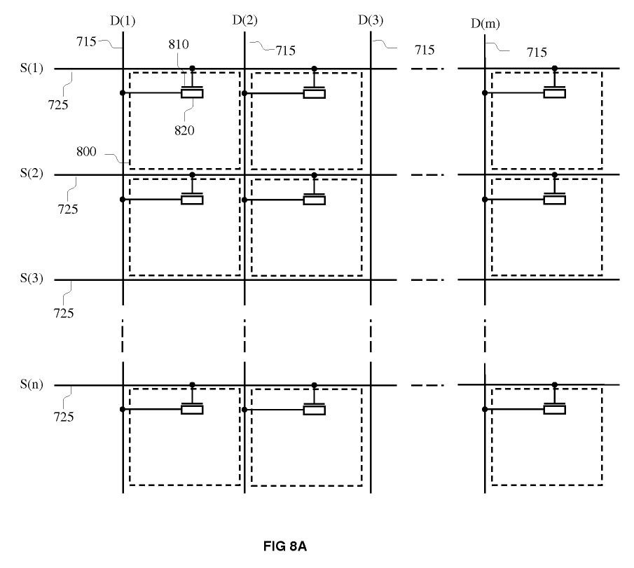

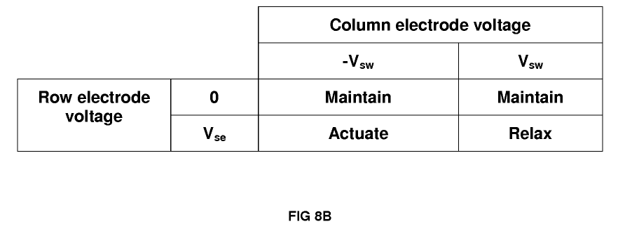

There are a variety of methods to control the array of display pixels to display text, an image, a sequence of moving images, or a combination of the above. The array of display pixels with data and scan line interconnects may be controlled, for example, by passive matrix addressing, in which the scan line interconnects and data line interconnects are directly connected to the display pixel electrodes. An example of the connection scheme for each display pixel 800 is shown in FIG. 8A, where the data line interconnects 715 are directly connected to the control electrode 810 and the scan line interconnects 725 are directly connected to the membrane electrode 820.

The operational states of a display pixel with the example connection scheme of FIG. 8A are shown in the table of FIG. 8B. The operational state of a display pixel is defined by the voltage signals applied to the row (scan) electrode and column (data) electrode connected to said display pixel. The position of the reflective membrane is defined by these voltage signals and the switching characteristic shown in FIG. 6. A switch voltage signal is selectively applied to the column electrodes. The high level of the switch voltage may be chosen to be less than the pull in voltage V_{P} but higher than the maintaining voltage V_{M}. The low level of the switch voltage may be chosen to be the same magnitude as the high level but of opposite polarity. A selection voltage is selectively applied to the row electrodes. The high level of the selection voltage V_{SE} may be chosen to satisfy the following conditions. Firstly, the magnitude of the difference between the high level of the selection voltage V_{SE} and the high level of the switch voltage ₊V_{SW} is less than the maintain voltage V_{M}. Secondly, the magnitude of the difference between the high-level of the selection voltage V_{SE} and the low level of the switch voltage ₋V_{SW} is greater than the pull-in voltage V_{P}. The above conditions are summarised below:

V_{M}<|V_{SW}|<V_{P}

|V_{SE}−V_{SW}|<V_{M}

|V_{SE}+V_{SW}|>V_{P}

The operational state of all display pixels in a single row may therefore be set by applying the high level of switch voltage signal V_{SE} to the respective row electrode. The voltage on the data lines then controls the state of the membranes in that row. If the voltage on the data line is +V_{SW}, then the potential difference between the membrane electrode and the control electrode is then V_{SE}+V_{SW}. Since the magnitude of this potential difference is larger than the pull-in voltage the membrane is electrostatically actuated and moves to the driven state. If the voltage on the data line is −V_{SW}, then the potential difference between the membrane electrode and the control electrode is V_{SE}−V_{SW}. Since the magnitude of this potential difference is less than the maintain voltage, the membrane moves by spring action to the relaxed state.

Whilst one row of the array of display pixels is being set, the operational state of the display pixels in all other rows is maintained. In order to achieve this, the low level of the selection voltage signal may be applied to all other rows in the array. Application of the +V_{SW} or −V_{SW} voltage on the column electrode will result in a potential difference between the membrane electrode and the control electrode of magnitude |V_{SW}|. Since this lies between the hold and maintain voltages, the membrane does not move and is maintained in its current position.

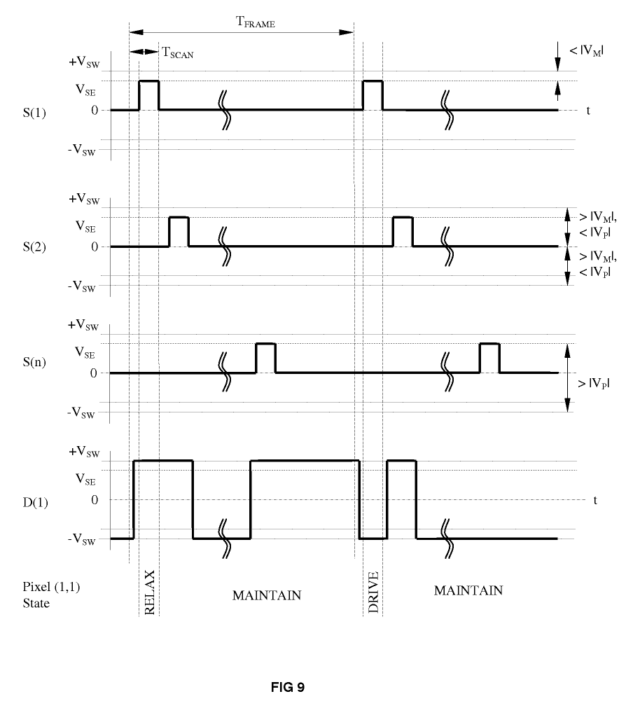

The operation of a display pixel is further described with reference to the waveform diagram of FIG. 9. During one row period, T_{SCAN}, switch voltages of either the high level +V_{SW} or the low level −V_{SW} are applied to each column (data) electrode D(1) . . . D(m) according to the desired reflectivity of each display pixel during the frame. The high level of select voltage V_{SE} is then applied to the row on which the display pixels are to be set. The membrane in each display pixel of this active row is then set according to the voltage on each respective column electrode. During one frame period of operation, T_{FRAME}, the display pixels of each row in the array are time sequentially set one row at a time by repetition of the above operation.

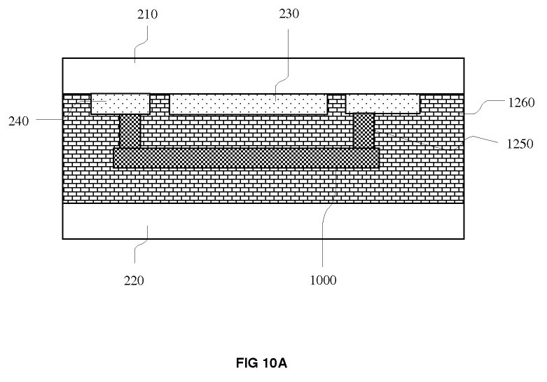

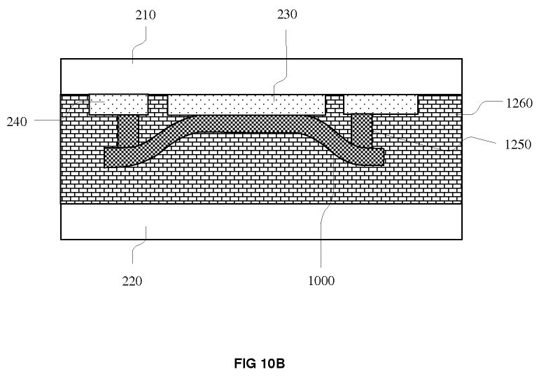

In accordance with the second embodiment of the invention, a display pixel comprises a reflective fluid and an absorbing membrane instead of an absorbing fluid and a reflective membrane. FIG. 10A shows a display pixel in accordance with this embodiment. The absorbing membrane 1000 is attached to the first transparent substrate 210 via membrane supports 1250. The membrane supports may attach directly to the substrate or to the membrane electrode which lies on the substrate. Membrane electrodes 240 on the first substrate electrically connect to the membrane, which may be electrically conductive. A control electrode 230 is positioned on the first substrate, electrically isolated from the membrane electrode. The control electrode surface, the membrane or both may be covered in an insulating layer to avoid electrical shorting of the membrane to the control electrode during operation. A second substrate 220 is positioned such that the absorbing membrane lies between the first and second substrates. The first and second substrates are sealed to form a cell which is filled with reflecting fluid 1260. The separation of the first and second substrate may be in the range 0.1 to 200 microns. The first substrate may be arranged so as to be closer to the viewer.

The absorbing membrane can be actuated in the same way as the reflective membrane described in the first embodiment. For example, by applying a potential difference between the control electrode and the membrane that is greater than the pull-in voltage, the actuated state of FIG. 10B can be achieved, while if the potential difference is removed the membrane relaxes to the state depicted in FIG. 10A. This produces at least two states where the membrane has a different average separation to the first transparent substrate 210. In the relaxed state the first average distance is large enough for the average thickness of the reflecting fluid in the void between the absorbing membrane and the control electrode or first transparent substrate to reflect a significant proportion of the incident light. The relaxed state therefore corresponds to a high reflectivity state. In the actuated state the second average distance is small enough that the average thickness of reflecting fluid in the void does not reflect a significant proportion of the incident light which is therefore substantially absorbed by the absorbing membrane. The driven state therefore corresponds to a low reflectivity state. Actuation of the membrane therefore allows switching between a high reflective state and a low reflective state.

In accordance with a third embodiment of the invention, electronic control elements are integrated onto the surface of the first substrate below the membrane. Example electrical control elements may include transistors, capacitors, diodes and resistors. These additional electrical elements may be fabricated on the surface of the first substrate using, for example, standard thin-film processing techniques as are well-known in the display industry. The array of display pixels of the present embodiment may therefore be controlled using an active matrix addressing scheme.

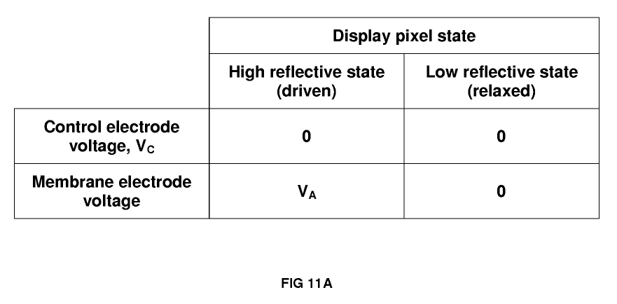

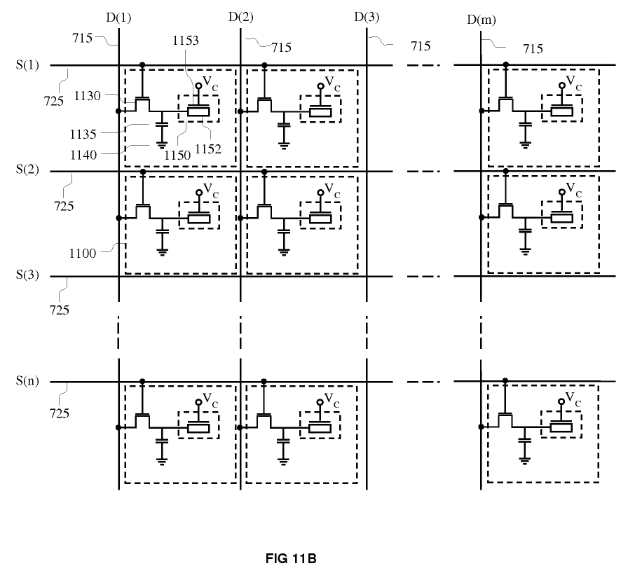

In an active matrix addressing scheme, an example of the voltages applied on the control and membrane electrodes of a display pixel is shown in FIG. 11A. The control electrode V_{C} is grounded to zero volts. The membrane electrode is switched between zero and an actuation voltage V_{A}, where V_{A} is greater than the pull-in voltage V_{P}. When the membrane electrode is at zero volts, the voltage difference between the membrane electrode and the control electrode is less than the maintain voltage, V_{M}. Therefore the membrane voltage controls the display pixel state, with zero volts corresponding to the relaxed state and V_{A} to the driven state.

To control the voltages on each membrane electrode in an array of display pixels in an active matrix addressing scheme, further electrical control elements are required. An example pixel circuit including electrical control elements is shown in FIG. 11B. A membrane assembly 1150 comprises a moveable reflective membrane connected to a membrane electrode 1152 and the control electrode 1153 that controls its movement. An example of a display pixel with active addressing 1100 comprises a membrane assembly 1150 and additional electrical control elements, for example a switch transistor 1130 and a capacitor 1135. A scan line interconnect 725 is connected to the gate of the transistor 1130 in each display pixel along one row. The source of the transistor 1130 is connected to a data line interconnect 715. One data line interconnect is connected to the source of the transistors in a column of display pixels. The drain of the transistor 1130 is connected to the membrane electrode and the storage capacitor 1135. The other terminal of the storage capacitor is connected to ground 1140. The control electrode may be globally connected to a drive voltage V_{C}. Using the example drive scheme in FIG. 11A, V_{C} is at the ground potential, 0V.

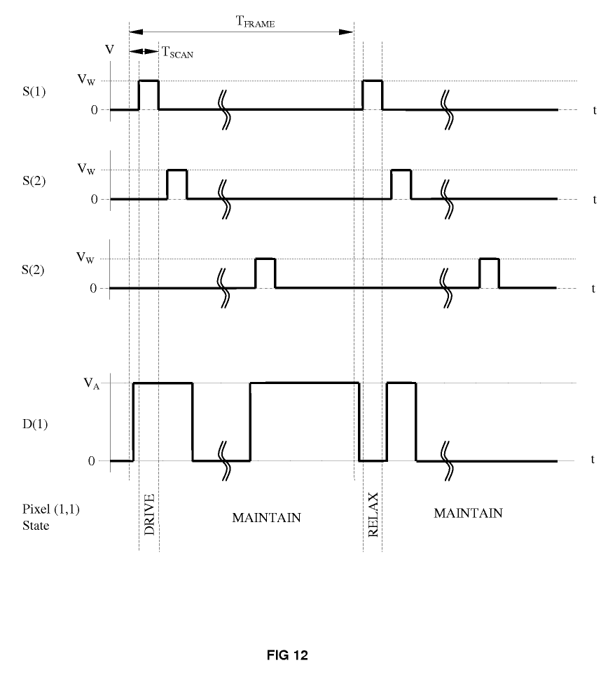

The operation of this example pixel circuit is described with reference to the waveform diagram of FIG. 12. During one row period of operation, T_{SCAN}, the operational state of each pixel in one row of the array is set. To enable the state of each pixel in the selected row to be updated a write-enabling voltage V_{w} is firstly applied to the respective scan line. The switch transistor 1130 of all pixels in the selected row is therefore turned on. Data voltage signals are then applied to the data line interconnects D(1) . . . D(m) and the membrane electrode and storage capacitor 1135 in each pixel of the selected row are charged to the respective voltage level of the data voltage signals. The data voltage levels may be either at an actuation voltage level of magnitude V_{A} which is larger than the pull-in voltage V_{P}, or at the ground potential. Selection of the data voltage level on a data line interconnect therefore allows the operational state of the membrane in the associated pixel in the selected row to be set according to the desired reflectivity. If the data line interconnect of a pixel is at the actuation voltage level the membrane is electrostatically actuated and moves to the driven state. If the data line interconnect of a pixel is at the ground potential the membrane is moved by spring action to the relaxed state. In this manner, during one frame period of operation, TFRAME, the operational state of each pixel in the array may be set by repeating the above operation for each row of the array in turn.

Since the electrostatic force is only dependent on the potential differences between electrodes, the electrical connections to the control and membrane electrodes may be swapped, and the operation of the membrane will occur in the same manner.

An active matrix addressing scheme can have several advantages over a passive matrix addressing scheme. The use of a storage capacitor means that the time to write data to one row can be shorter than the time to move the membrane. This means that update of the entire array can be quicker, allowing higher frame rates, and the potential for higher colour depth. An active matrix addressing scheme can use lower power than a passive matrix scheme. For example, consider a membrane which does not need to change state on an update of the array of display pixels. In an active addressing scheme, no voltage change is applied to the membrane or control electrode, so no power is dissipated there. For a passive matrix scheme, the voltage may change depending upon the data written to other display pixels in the same column, dissipating power in the capacitance formed between the membrane and the control electrode. In addition active matrix addressing can use lower voltages on the scan lines used to control the data written to the display pixel than the voltages required to move the membrane. This can also reduce the power requirements.

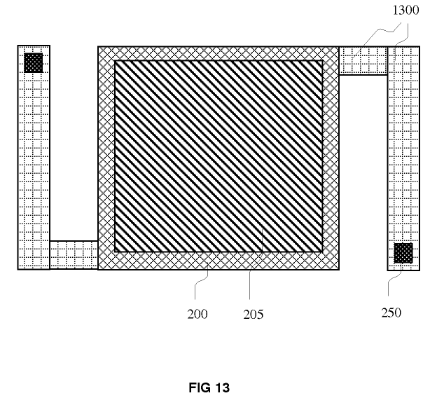

In accordance with a fourth embodiment of the invention, the membrane supports may be laterally separated from the membrane. A plan view of an example of such a membrane is shown in FIG. 13. For example the membrane supports 250 may be connected to the membrane 200 by linking elements 1300. These linking elements may be substantially in the same plane as the membrane or in a plane parallel to the plane of the membrane. These linking elements may have a width smaller than the membrane width. Therefore on movement of the membrane, the curvature of the linking elements may be higher than the curvature of the membrane. An advantage of using these linking elements is that they can lower the mechanical restoring force when a distortion of the structure occurs. This can lower the required voltage for electrostatic actuation. The use of these linking elements can also lower the influence of any initial stress in the structure created during device fabrication. However the use of these linking elements can decrease the speed of any actuation which relies on mechanical restoring forces, for example moving from the driven to the relaxed state.

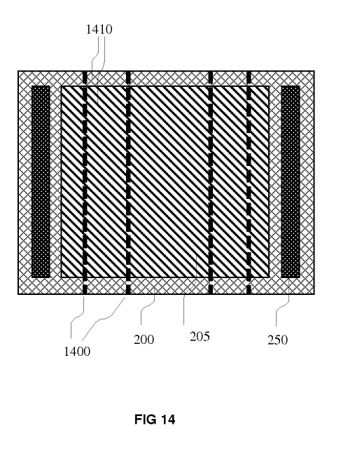

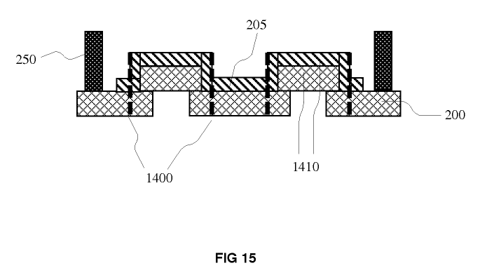

In accordance with a fifth embodiment of the invention out of plane elements may be added to the membrane or membrane linking elements. These out of plane elements may include ribs. An example of out of plane elements is shown in a plan view in FIG. 14 and a side view in FIG. 15. The reflective membrane has lines where there is a change of plane 1400 in the reflective membrane. This results in some regions of the membrane, and optionally the reflective surface, existing in a different plane, creating a rib 1410. The region 1410 in a different plane may be in a second plane substantially parallel to the plane of the remainder of the membrane. Out of plane features may also include additional layers in some regions on a side of the membrane. Out of plane features may include variations in the thickness of the reflective membrane. These out of plane elements may be used to modify the voltage required to electrostatically actuate the membrane. These out of plane elements may be used to reduce the influence of any initial stress in the structure created during device fabrication.

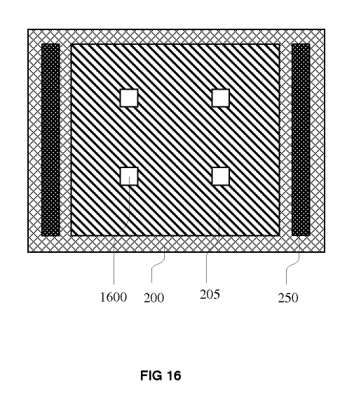

A membrane structure in accordance with a sixth embodiment of the invention is shown in FIG. 16. This shows a plan view of a reflective membrane with holes 1600 through the reflective membrane. These holes through the reflective membrane can occur in areas of the membrane or in areas of the membrane and reflective surface. The addition of these holes allows an additional path for fluid flow during membrane movement. These holes can therefore speed up membrane movement. However addition of these holes can reduce the average reflectivity of the pixel.

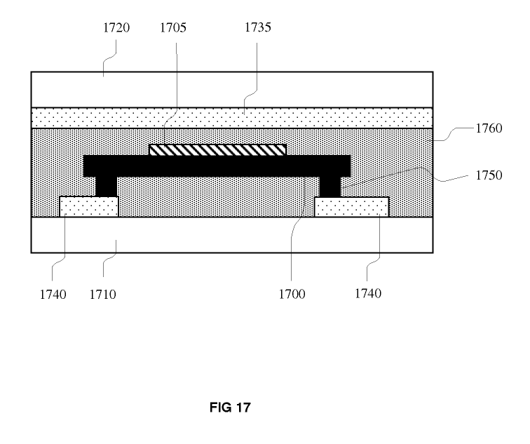

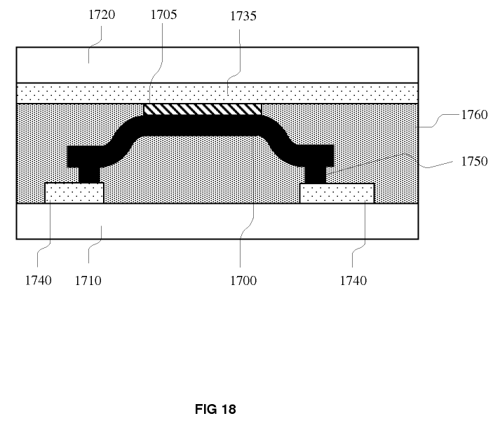

In accordance with a seventh embodiment of the invention, the display pixel has the structure shown in FIG. 17. The membrane 1700 forms a reflective membrane with a reflective surface 1705. The membrane is attached to the first substrate 1710 via membrane supports 1750. Membrane electrodes 1740 on the first substrate electrically connect to the membrane, which may be electrically conductive. A second substrate 1720 which is substantially transparent is positioned such that the reflective membrane lies between the first and second substrates. A control electrode 1735 lies on the second substrate on the side nearest the membrane. Therefore the membrane and control electrodes are on different substrates. The first and second substrates are sealed to form a cell which is filled with absorbing fluid 1760. The membrane may be actuated to at least two different states, with two example states shown in FIGS. 17 and 18. In FIG. 18 the control electrode electrostatically actuates the membrane by applying a potential difference between the membrane electrode and the drive electrode. The membrane returns to its original state by the mechanical spring restoring force of the membrane or the membrane supports. An advantage of this arrangement is that the electrical control elements for an active matrix addressing scheme can be positioned on the substrate furthest from the viewer. This improves the transparency of the transparent substrate closest to the viewer. The substrate closest to the viewer may only require a global electrode. This eases manufacture, as patterning of only one of the substrates, the substrate furthest from the viewer, is required to form both the membrane and any active addressing electrical control elements. In this configuration the electrical control elements for active addressing may be positioned under the reflective membrane. This allows the reflective membrane to occupy a high proportion of the area of a display pixel, resulting in the potential for a high pixel reflectivity.

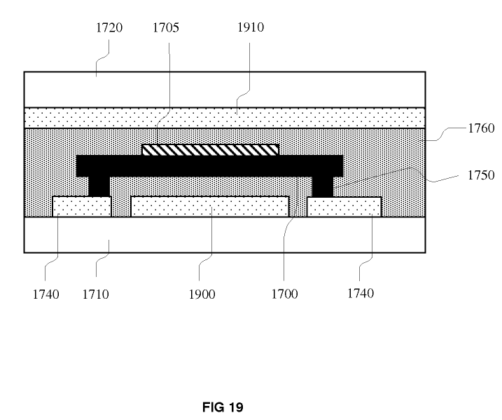

FIG. 19 shows a display pixel in accordance with an eighth embodiment of the invention. The membrane 1700 forms a reflective membrane with a reflective surface 1705. The membrane is attached to the first substrate 1710 via membrane supports 1750. The membrane supports may attach directly to the substrate or to the membrane electrode which lies on the substrate. Membrane electrodes 1740 on the first substrate electrically connect to the membrane, which may be electrically conductive. Two further electrodes are included. A return electrode 1900 is positioned on the first substrate, electrically isolated from the membrane electrode. The return electrode 1900 may be a common or global electrode for all display pixels. A second substrate 1720 which is substantially transparent is positioned such that the reflective membrane lies between the first and second substrates. A drive electrode 1910 lies on the second transparent substrate on the side nearest the reflective membrane. The drive electrode 1910 may be a common or global electrode for all display pixels. The electrode surfaces, the membrane or both may be covered in an insulating layer to avoid electrical shorting of the membrane to the drive or return electrodes during operation. The first and second substrates are sealed to form a cell which is filled with an absorbing fluid 1760. The separation of the first and second substrate may be in the range 0.1 to 200 microns.

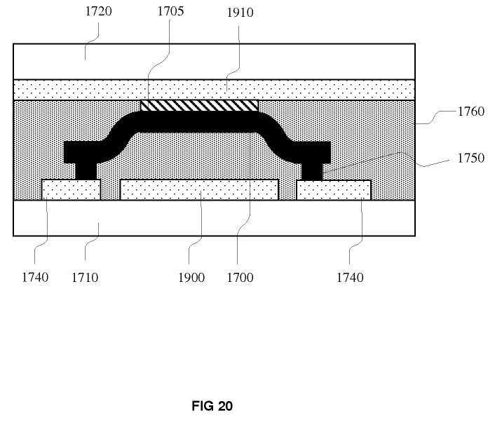

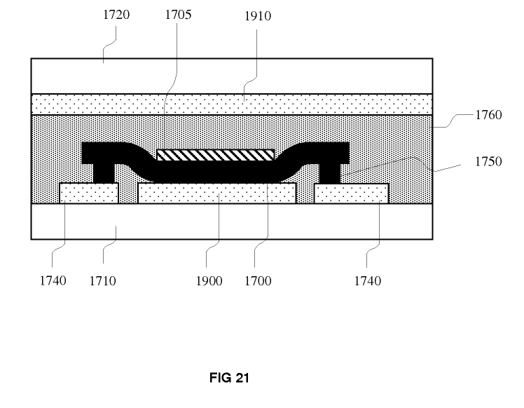

The reflective membrane may be controlled to move between two different states corresponding to a difference in the location of the membrane relative to the second transparent substrate. FIG. 20 illustrates the driven state where the membrane is pulled in towards the drive electrode by an electrostatic force generated by a potential difference between the membrane electrode and the drive electrode. In the driven state the membrane is separated from the drive electrode by a first average distance. This driven state may be achieved when the potential difference between the drive electrode and membrane electrode, W_{DM}, is greater than a first pull-in voltage, V_{P1}. FIG. 21 illustrates the returned state where the membrane is pulled in towards the return electrode by an electrostatic force generated by a potential difference between the membrane electrode and the return electrode. In the returned state the membrane is separated from the drive electrode by a second average distance that is larger than the first average distance in the driven state. The returned state may be achieved when the potential difference between the return electrode and the membrane electrode, V_{RM}, is greater than a second pull-in voltage, V_{P2}. Switching between the driven and returned states is therefore achieved by electrostatic actuation. Switching between driven and returned states may be achieved by a combination of electrostatic actuation and the mechanical spring force. For example, the mechanical restoring force may dominate in the first portion of the movement from one state to another, and the electrostatic attraction may dominate in the second portion of the movement from one state to another. An advantage of using a drive and a return electrode is that by using electrostatic actuation to actuate both drive and return states the membrane can be actuated faster and more symmetrically.

Switching from the driven state to the returned state requires that the potential difference between the drive electrode and the membrane, W_{DM}, to be less than a first maintain voltage, V_{M1}, and that potential difference between the return electrode and the membrane electrode, V_{RM}, is greater than the second pull-in voltage, V_{P2}. Switching from the returned state to the driven state requires that the potential difference between the return electrode and the membrane, V_{RM}, is less than a second maintain voltage, V_{M2}, and that potential difference between the return electrode and the membrane, W_{DM}, is greater than the first pull-in voltage, V_{P1}. The electro-mechanical characteristic of the membrane with a potential difference between the membrane electrode and either the drive or the return electrode is illustrated in FIG. 6.

In the driven state the first average distance between the drive electrode and the reflective membrane is small enough that the average thickness of absorbing fluid in the void between the reflective membrane and the drive electrode or second transparent substrate does not absorb a significant proportion of the incident light which is substantially reflected back to the viewer. The driven state therefore corresponds to a high reflectivity state. In the returned state the second average distance between the reflective membrane and the drive electrode is large enough for the average thickness of the absorbing fluid in the void to absorb a significant proportion of the incident light. The returned state therefore corresponds to a low reflectivity state. Actuation of the membrane therefore allows switching between a high reflective state and a low reflective state.

The position of the reflective membrane in the returned or driven states may be in contact with the return electrode or drive electrode respectively. Alternatively, the membrane may not be in contact with the return or drive electrodes. In the latter case there exists an absorbing fluid filled gap between the reflective membrane and the drive and return electrodes at all times. Such a non-contact state may be used as an additional intermediate state, and can be actuated by a potential difference between the membrane and the drive or return electrode that is less than the corresponding pull in voltage. The reflective surface may only partially contact the opposite surface, for example the drive electrode. The reflective membrane may contact only one of the drive electrode and return electrode.

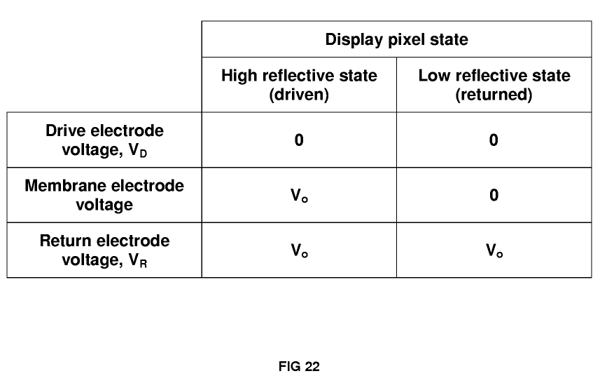

An example voltage driving scheme for an individual display pixel, such as is shown in FIG. 19, is shown in FIG. 22. The drive electrode and return electrode are held at two different voltages, for example ground (0 V) and Vₒ respectively. The membrane electrode voltage can be switched between these two voltages. Vₒ is greater than the pull-in voltages for the drive and return electrodes V_{P1} and V_{P2}. If the membrane electrode is at 0 V, the potential difference between the membrane electrode and the drive electrode, V_{DM}, is 0 V, less than the maintaining voltage V_{M1}. The potential difference between the membrane electrode and the return electrode, V_{RM}, is equal to Vₒ, greater than the corresponding pull-in voltage V_{P2}. The membrane therefore moves to the returned state. If the membrane electrode is equal to Vₒ, V_{RM} is equal to 0 V, less than the maintaining voltage V_{M2}, while V_{DM} is greater than the corresponding pull-in voltage V_{P2} In this case the membrane then moves to the driven state. Therefore the reflective membrane may be actuated between two different states, the driven and returned states which correspond to the high and low reflective states of the display pixel. The membrane electrode may be set to a voltage between the voltage on the drive and return electrodes to achieve an intermediate state.

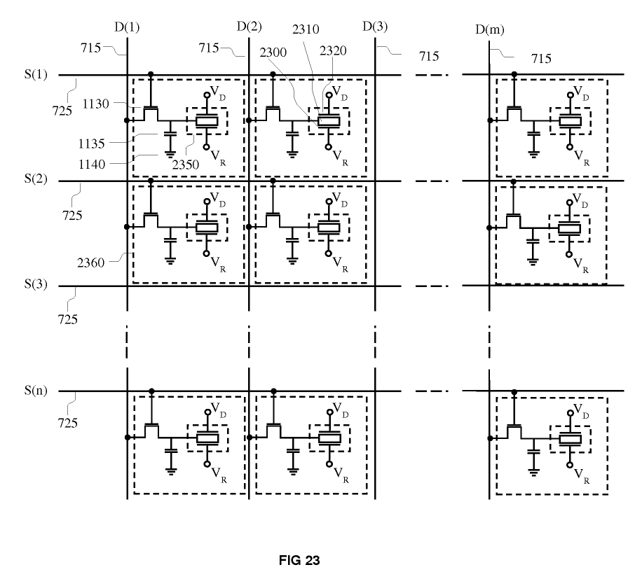

FIG. 23 shows an example of the pixel circuits for each of the membrane assemblies 2350 that can be used in an active matrix addressing scheme. A membrane assembly comprises a moveable reflective membrane connected to a membrane electrode and the electrodes that control its movement. For example a membrane assembly may comprise a moveable reflective membrane connected to a membrane electrode 2310, and a drive electrode 2320 and a return electrode 2300. An example of a display pixel with active addressing 2360 comprises a membrane assembly 2350 and at least one additional electrical control element, for example a transistor 1130 and a capacitor 1135. A scan line interconnect 725 is connected to the gate of the transistor 1130 in each display pixel along one row. The source of the transistor 1130 is connected to a data line interconnect. One data line interconnect 715 is connected to the source of the transistors in a column of display pixels. The drain of the transistor 1130 is connected to the membrane electrode 2310 and the storage capacitor 1135. The other terminal of the storage capacitor is connected to ground 1140. The drive 2320 and return 2300 electrodes (the other terminals of the membrane assembly) may be globally connected to a drive voltage V_{D} and a return voltage V_{R}. Using the example drive scheme in FIG. 22, V_{D} is grounded while V_{R}=Vₒ.

In operation of this example pixel circuit, the display pixel state is written in a row by row manner, in a similar manner to the third embodiment. This is achieved by application of a write-enabling voltage V_{w} to each scan line interconnect in turn. Upon application of V_{w} to a scan line interconnect, V_{w} is applied to the gates of all the transistors in that row of display pixels. This enables current to flow between the source and drain terminals of the transistors in that row. Therefore voltage signals applied to the data line interconnects are written to the membrane electrode and stored in the storage capacitor in that row of display pixels. By either applying Vₒ or 0 V to the data line interconnects, this voltage is then applied to the membrane electrode, resulting in the actuation of the membrane to two possible states, as shown in the drive scheme for an individual pixel in FIG. 22. In this manner an entire array of display pixels can be controlled by controlling each row sequentially. The use of a storage capacitor means that the duration of the write enabling pulse on the signal line may be shorter than the time required to move the membrane. If the duration of the write pulse is longer than the membrane movement time, the storage capacitor may be omitted.

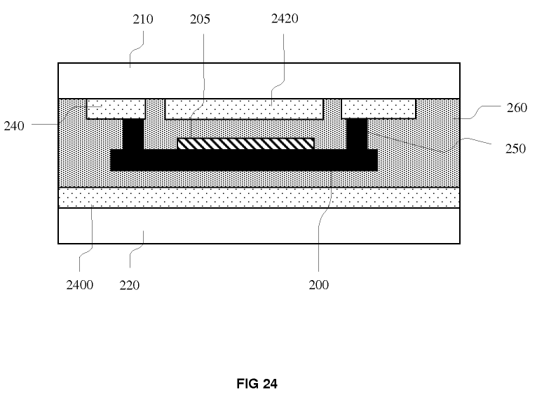

In accordance with a ninth embodiment of the invention, the display pixel has the structure shown in FIG. 24. The membrane 200 with the reflective layer 205 forms a reflective membrane. The membrane is attached to the first substrate 210 via membrane supports 250. Membrane electrodes 240 on the first substrate electrically connect to the membrane, which may be electrically conductive. A drive electrode 2420 is positioned on the first substrate, electrically isolated from the membrane electrode. The first substrate is substantially transparent. A second substrate 220 is positioned such that the reflective membrane lies between the first and second substrates. A return electrode 2400 is positioned on the second substrate, on the side closest to the membrane. The first and second substrates are sealed to form a cell which is filled with absorbing fluid 260.

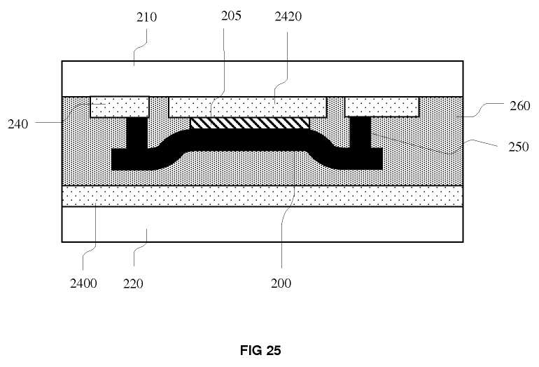

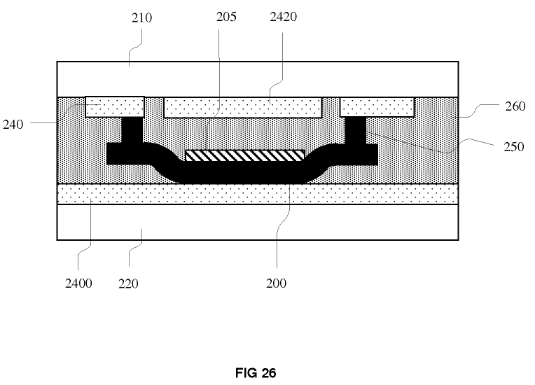

The reflective membrane may be actuated to two different states, as shown in FIGS. 25 and 26. This actuation may be electrostatic, by applying a potential difference between the reflective membrane and the drive electrode or between the reflective membrane and the return electrode. This actuation changes the average separation of the reflective membrane to the first transparent substrate 210. This changes the average thickness of the absorbing fluid between the reflective membrane and the first transparent substrate or drive electrode. This changes the intensity of the reflected light. Therefore the actuation of the membrane allows switching between a high reflective state and a low reflective state. Switching between intermediate states is also possible. The actuation of the membrane may occur by using potential differences between the membrane and the drive or return electrode which are above the pull in voltage for the membrane, so that the membrane only reaches equilibrium in contact with another surface, for example the drive or return electrode surface. The electrode surfaces, the membrane or both may be covered in an insulating layer to avoid shorting of the membrane to the drive or return electrode during operation. The actuation positions shown in FIGS. 25 and 26 may instead not require contact of the reflective membrane to the drive or return electrodes, with an absorbing fluid filled gap between the reflective membrane and the drive and return electrodes at all times. The reflective surface may only partially contact the opposite surface, for example the drive electrode. The actuation of the membrane may also be caused wholly or in part by structural restoring forces due to distortion of the membrane or the membrane supports.

An advantage of this configuration may be that it is easier to fabricate the membrane closer to the drive electrode than the return electrode. This may make it easier to make a high reflective state with a high reflectivity, as it may be easier to achieve to achieve a large area of contact between the reflective membrane and the drive electrode in the driven state.

In accordance with a tenth embodiment of the invention, the reflected light from a display pixel may substantially reflect light in a diffuse manner. The reflective part of the membrane may substantially reflect light in a diffuse manner by modification of the surface of the membrane or modification of the surface of the optional additional layer which makes part of the membrane reflective. For example the surface may have a random or partially random surface texture. Alternatively, the reflective membrane may substantially reflect light in a specular manner, and an additional optical element at least partially scatters the light in a diffuse manner, acting as an optical diffuser. The optical diffuser may be added in a number of different positions in the device.

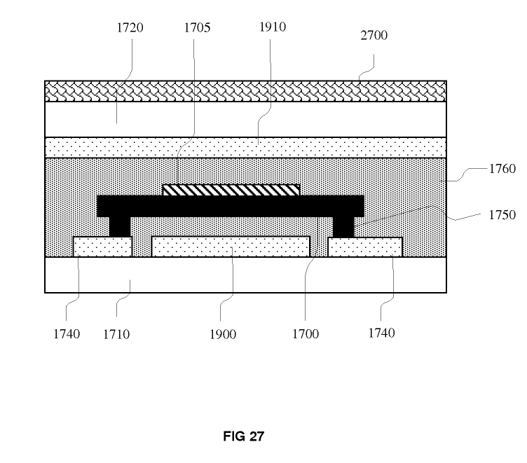

FIG. 27 shows the addition of an optical diffuser 2700 to the side of the second transparent substrate closest to the viewer (e.g., an outer surface of the substrate).

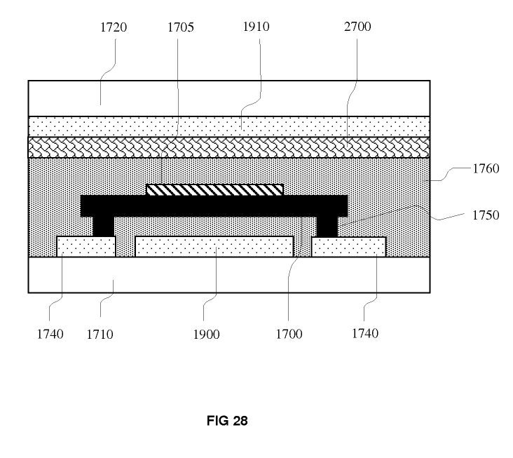

FIG. 28 shows the addition of an optical diffuser 2700 to the side of the second transparent substrate furthest from the viewer (e.g., between the first and second substrates), with the drive electrode 1910 between the second transparent substrate 1720 and the optical diffuser 2700.

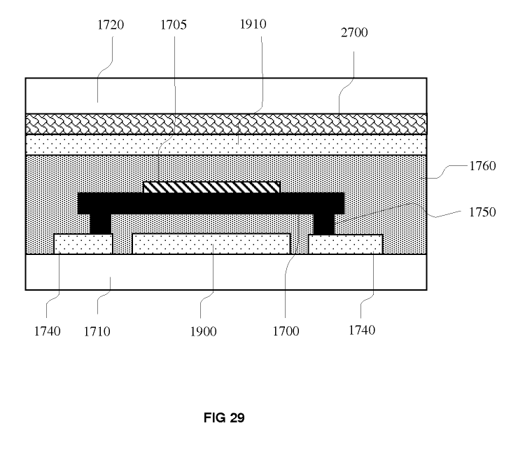

FIG. 29 shows the addition of an optical diffuser 2700 to the side of the second transparent substrate furthest from the viewer (e.g., between the first and second substrates), with the optical diffuser 2700 between the second transparent substrate 1720 and the drive electrode 1910.

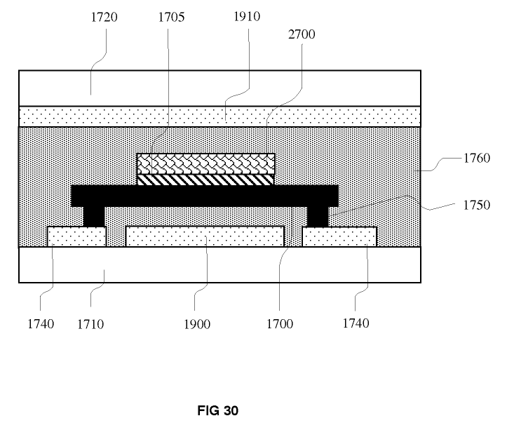

FIG. 30 shows the addition of an optical diffuser 2700 to the reflective membrane. The optical diffuser may be deposited over the whole or part of the reflective surface 1705. The optical diffuser may be deposited over the whole or part of the membrane 1700. The optical diffuser may be deposited over at least part of the optional reflective layer and at least part of the membrane.

In accordance with a eleventh embodiment of the invention the scattering of light may be produced by texturing a surface.

In accordance with a twelfth embodiment of the invention the display pixels may generate intermediate light intensities between a high and low reflective state. The intermediate light intensities may be generated by using membrane positions in between the positions for high and low reflective states, directly generating intermediate light intensities.

In accordance with an thirteenth embodiment intermediate light intensities may be generated by using a time average of different time durations in different states. These time durations are shorter than those which can be perceived by an average human viewer. As a result, the average reflected light intensity is perceived by the viewer as an intermediate light intensity. For example, by adjusting the amount of time a display pixel is in a high reflective state compared to a low reflective state, the time averaged pixel state observed by a viewer may consist of an intermediate reflective state. This may be used to produce a range of reflective intensities, for example to produce a greyscale reflective image. This method can be described as time-sequential greyscale.

In accordance with a fourteenth embodiment of the invention the display pixels may use different states in nearby display pixels to generate apparent average intermediate reflective states to a viewer over a number of display pixels. For example spatial dithering may be used. Spatial dithering may further be combined with time-sequential greyscale techniques to increase the image appearance.

In accordance with a fifteenth embodiment of the invention, a colour filter may be applied between the reflective membrane and the viewer. The colour filter may be applied onto the substrate nearest the viewer. The colour filter may be applied to the membrane. Different colour filters may be used for different display pixels. For example, groups of three display pixels with either a red, blue or green colour filter may be formed. This group of pixels allows colours to be displayed to a viewer. Colour filters may further be combined with intermediate reflective states to produce a large range of colour observable by a viewer. The intermediate reflective states may be created by using at least one of: intermediate states in one pixel, a time average of at least two different states in one pixel and a spatial average over several display pixels.

In accordance with a sixteenth embodiment of the invention the display pixels may be used in a lower power latch mode to maintain their state. For example, in the third and eighth embodiments, once the reflective membrane has been moved to a state either by an electrostatic force or a mechanical restoring force, it is latched to this state. Very little power is required to maintain this state, as any voltage loss across the membrane is driven only by leakage currents, for example across the capacitor, transistor or membrane. Therefore this state should only require an occasional rewriting of the display data, at a frequency much lower than the normal refresh rate of the display. Such a low power state may be useful when displaying static images or text. The reflective display may switch between this low power mode and a higher power mode. A higher power mode may allow higher frame rates for moving images and may allow better colour depth. Different regions of the display may independently switch between low and high power modes.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention finds application in displays for industrial and consumer devices. The invention is especially suited for use in tablets, e-readers, mobiles, watches and other wearable or portable displays.

1. A reflective pixel for a display device, comprising:
a first substrate;
a membrane formed relative to the first substrate;
a fluid arranged between the first substrate and the membrane; and
an actuator mechanism operative to move the membrane between at least a first and second position that differ in average separation distance relative to the first substrate to produce a low reflective state and a high reflective state of the pixel.

2. The reflective pixel according to claim 1, where the membrane is a reflective membrane and the fluid is an optically absorbing fluid.

3. The reflective pixel according to claim 1, where the membrane is an optically absorbing membrane and the fluid is a reflective fluid.

4. The reflective pixel according to claim 1, wherein the actuator mechanism comprises:
a membrane electrode electrically connected to the membrane;
a control electrode electrically isolated from the membrane electrode; and
a controller operatively coupled to at least one of the membrane electrode or the control electrode and operative to electro-statically actuate the membrane through application of a potential difference between the membrane electrode and the control electrode.

5. The reflective pixel according to claim 4, wherein the controller is configured to produce an intermediate reflective state of the pixel by varying a time duration in which the membrane is in the low reflective state and the high reflective state.

6. The reflective pixel according to claim 4, wherein the controller is configured to generate an average intermediate reflective state by placing the pixel in one reflective state and at least one adjacent pixel in a different reflective state.

7. The reflective pixel according to claim 2, wherein the membrane comprises a reflective layer formed on at least a portion of the membrane.

8. The reflective pixel according to claim 2, wherein the membrane is formed from a reflective material.

9. The reflective pixel according to claim 1, wherein the first substrate is substantially transparent to visible light.

10. The reflective pixel according to claim 1, further comprising a second substrate arranged relative to the first substrate, wherein the reflective membrane is arranged between the first substrate and the second substrate, and at least one of the first and second substrate is substantially transparent to visible light.

11. The reflective pixel according to claim 10, where the fluid arranged between the membrane and the first substrate is also arranged between the second substrate and the membrane.

12. The reflective pixel according to claim 10, further comprising a membrane support attached to the membrane and one of the first substrate or the second substrate.

13. The reflective pixel according to claim 12, wherein the membrane support is laterally separated from the membrane and further comprising a linking element connected between the membrane and the membrane support.

14. The reflective pixel according to claim 1, further comprising a plurality of electronic control elements integrated into a surface of one of the first substrate or the second substrate.

15. The reflective pixel according to claim 12, wherein at least a first portion of the membrane or linking element lies in a first plane, and a second portion of the membrane or linking element lies in a second plane different from the first plane.

16. The reflective pixel according to claim 1, wherein the membrane comprises at least one hole that enables the fluid to pass therethrough.

17. The reflective pixel according to claim 10, wherein the membrane is attached to one of the first substrate or the second substrate, and the control electrode is attached to the same first substrate or second substrate.

18. The reflective pixel according to claim 10, wherein the membrane is attached to one of the first substrate or the second substrate, and the control electrode is attached to the other of the first substrate or the second substrate.

19. The reflective pixel according to claim 10, further comprising:
a return electrode arranged on one of the first substrate or the second substrate, the return electrode electrically isolated from the membrane; and
a drive electrode arranged on the other of the first substrate or the second substrate, the drive electrode electrically isolated from the membrane, where when in the first position the membrane is separated from the drive electrode by a first average separation distance, and when in the second position the membrane is separated from the drive electrode by a second average separation distance, the first average separation distance being different from the second average separation distance.

20. The reflective pixel according to claim 1, wherein the membrane is configured to diffusely reflect light.

21. The reflective pixel according to claim 1, further comprising an optical diffuser.

22. The reflective pixel according to claim 1, further comprising a color filter.

23. A display device comprising a plurality of reflective pixels according to claim 1.
